(19) United States
(12) Patent Application Publication
(10) Pub. No.: US 2009/0161253 A1
(43) Pub. Date: Jun. 25, 2009

(54) BEARING MECHANISM, MOTOR AND STORAGE DISK DRIVE APPARATUS

(75) Inventors: Hirokazu SHIRAI, Kyoto (JP); Yoichi SEKII, Kyoto (JP); Masato GOMYO, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 12/333,346

(22) Filed: Dec. 12, 2008

(30) Foreign Application Priority Data
Dec. 21, 2007 (JP) 2007-330362

(51) Int. Cl. G11B 17/02; F16C 32/06; H02K 5/16

(52) U.S. Cl. 360/99.08; 384/107; 310/90; G9B/17.002

(57) ABSTRACT

A bearing mechanism includes a cylindrical bottom-closed sleeve unit; a shaft unit radially supported by the sleeve unit via a lubricant; and an elastic thrust plate on an inner bottom surface of the sleeve unit to contact an end portion of the shaft unit at a position on a central axis to rotatably support the shaft unit. The shaft unit has a first contact portion, and the sleeve unit has a second contact portion. The contact portions are so arranged that, when a force acting from above the inner bottom surface is applied, movement of the shaft unit is restrained by the contact portions making contact with each other. Further, a distance between the contact portions prior to the force being applied is smaller than the displacement of the shaft unit at which the thrust plate gets so pressed by the shaft unit to be permanently deformed.

### FIELD OF THE INVENTION

The present invention relates to a bearing mechanism having a pivot bearing.

### BACKGROUND OF THE INVENTION

In recent years, there has been proposed a bearing mechanism used for a spindle motor in a storage disk drive apparatus, which includes a dynamic pressure bearing for radially supporting a shaft inserted into a sleeve by a dynamic fluid pressure of a lubricant, and a pivot bearing for axially supporting the shaft by bringing the tip end of the shaft into pointwise contact with a thrust plate.

Japanese Patent Application Publication No. 2005-113987 discloses a pivot bearing in a bearing mechanism, in which a shaft has a lower shaft portion with a spherical tip end, and an upper shaft portion with a diameter smaller than that of the lower shaft portion. The lower shaft portion is inserted into a sleeve in a substantially cylindrical bottom-closed sleeve holder portion. The tip end of the lower shaft portion comes into pointwise contact with a thrust plate arranged in the center of a bottom surface of the sleeve holder portion. Japanese Patent Application Publication No. 2005-113987 also discloses a motor in which an annular removal-preventing portion is provided in an opening of the sleeve holder portion, wherein the removal-preventing portion is fitted to the upper shaft portion, and has an inner diameter smaller than the diameter of the lower shaft portion. When the shaft is moved away from the sleeve, the removal-preventing portion makes contact with the lower shaft portion to restrain the movement of the shaft.

Japanese Patent Application Publication No. 2002-78280 discloses a bearing mechanism that includes a plate-like thrust rest for closing an opening formed at one end of a sleeve. A dish spring and a bottom plate for holding the dish spring are arranged in a mutually adjoining relationship on a surface of the thrust rest facing away from a surface that contacts a shaft. If the pressure of the shaft acting on the thrust rest becomes greater in a vibrating environment, the dish spring is elastically deformed to permit displacement of the thrust rest. Thus, the shock applied to the thrust rest is absorbed, thereby preventing the thrust bearing from suffering from reduction in its life span. If the vibration amplitude of the dish spring is properly selected so as to make the thrust rest displaceable within a certain distance, and the movement range of a rotor to which the shaft is fixed can be kept within a certain extent, it is possible to prevent a disk mounted on the rotor from contacting a recording/reproducing head, which might otherwise occur when a motor is assembled into a storage disk drive apparatus.

Further, Japanese Patent Application Publication No. 2005-353109 discloses a storage disk drive apparatus that includes a ramp member for receiving a plurality of floating head sliders, each of which is designed to access both surfaces of a storage disk mounted to a motor to thereby read and write data. A reception groove for receiving a part of the outer periphery of the storage disk is formed at the tip end of the ramp member. Slanting surfaces for guiding the floating head sliders to the ramp member are formed above and below the reception groove. When moving away from the storage disk, the floating head sliders are moved along the slanting surfaces and then received within the ramp member.

However, in a bearing mechanism with a pivot bearing, a shaft may excessively press the thrust plate because it makes pointwise contact with the thrust plate. This may cause damage to the thrust plate or plastic deformation in the housing.

Further, in a storage disk drive apparatus including a ramp member arranged near the storage disk, the displacement of a shaft needs to be increased for absorbing the shock applied to a thrust rest by a dish spring or a synthetic rubber seat as disclosed in Japanese Patent Application Publication No. 2002-78280. Therefore, there is a concern that the storage disk may come into contact with the ramp member.

Furthermore, a bearing mechanism disclosed in Japanese Patent Application Publication No. 2002-78280A has a large number of parts and a complicated structure, which may increase manufacturing steps and production costs.

### SUMMARY OF THE INVENTION

In accordance with one aspect of the present invention, there is provided a bearing mechanism including a substantially cylindrical bottom-closed sleeve unit; a shaft unit supported by the sleeve unit via a lubricant in a radial direction; and an elastic thrust plate arranged on an inner bottom surface of the sleeve unit to be in contact with an end portion of the shaft unit at a position on a central axis to rotatably support the shaft unit in an axial direction,

Herein, the shaft unit has a first contact portion, and the sleeve unit has a second contact portion. The first contact portion and the second contact portion are so arranged that, when a force acting from above the inner bottom surface of the sleeve unit is applied to the shaft unit, movement of the shaft unit is restrained by the first and the second contact portion making contact with each other. Further, a distance between the first and the second contact portion prior to the force being applied to the shaft unit is smaller than the displacement of the shaft unit at which the thrust plate gets so pressed by the shaft unit to be permanently deformed.

With the present invention, damage of a thrust plate is prevented by restraining movement of a shaft unit. Furthermore, rigidity is secured without having to overly increase the thickness of a sleeve housing, which assists in preventing contact between a removal-preventing member and an annular portion of the sleeve housing. In addition, it is possible to prevent contact between a ramp and a storage disk.

### BRIEF DESCRIPTION OF THE DRAWINGS

The above features of the present invention will become apparent from the following description of preferred embodiments, given in conjunction with the accompanying drawings, in which:

FIG. 1 is a sectional view showing a storage disk drive apparatus in accordance with a first embodiment of the present invention, which view is taken along a plane containing a central axis of the apparatus;

FIG. 2 is a plan view illustrating the placement of a ramp and an access unit;

FIG. 3 is a sectional view illustrating the placement of the ramp and the access unit;

FIG. 4 is a sectional view showing a motor;

FIG. 5 is a plan view showing a removal-preventing member;

FIGS. 6 through 9 are views enlargedly showing the bottom portion of a sleeve unit and its neighborhood;

FIG. 10 is a view showing a modified example of the structure for restraining movement of the shaft;

FIG. 11 is a view showing a structure for restraining movement of a shaft in accordance with a second embodiment;

FIG. 12 is a view enlargedly showing a removal-preventing member and its neighborhood;

FIG. 13 is a view showing a modified example of the structure for restraining movement of the shaft;

FIG. 14 is a view representing the relationship between the thickness of the bottom portion of the sleeve housing and the displacement of the sleeve housing caused by pressing the shaft; and

FIGS. 15 and 16 are views enlargedly showing the bottom portion of the sleeve unit and its neighborhood.

### DETAILED DESCRIPTION OF THE PREFERRED EMBODIMENTS

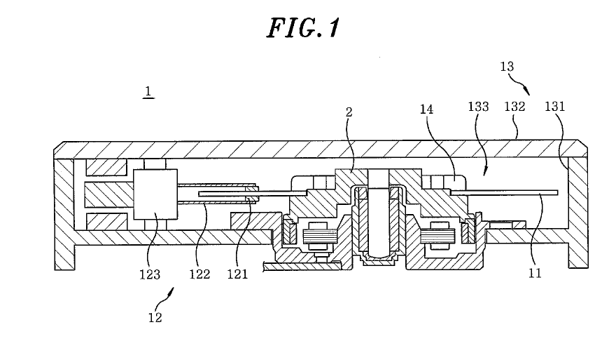

FIG. 1 is a sectional view showing a storage disk drive apparatus 1 provided with a spindle motor (hereinafter referred to as a “motor”) in accordance with a first embodiment of the present invention, which view is taken along a plane containing a central axis of the apparatus 1. In the description made herein, the terms “upper”, “lower”, “left” and “right” used for explaining the positional relationships and orientations of elements are intended to designate those in the drawings, and not to designate those in a state that they are assembled into an actual device.

The storage disk drive apparatus 1 is exemplified as a hard disk drive, and includes a circular plate-like storage disk 11 for storing data; an access unit 12 for reading and writing data from and to the storage disk 11; a motor 2 for rotating the storage disk 11; and a housing 13 for receiving the storage disk 11, the motor 2 and the access unit 12 within an internal space thereof to isolate them from the outside. The storage disk drive apparatus 1 further includes a later-described ramp (not shown) for receiving a head portion 121 of the access unit 12 when the apparatus 1 is not in operation.

The housing 13 includes a first housing member 131 of cover-free box-like shape. The first housing member 131 has an opening formed in its upper portion, an inner bottom surface on which the motor 2 and the access unit 12 are mounted, and a second housing member 132 of plate-like shape for covering the opening of the first housing member 131 to define an internal space 133. In the storage disk drive apparatus 1, the second housing member 132 is affixed to the first housing member 131 to shape the housing 13. The internal space 133 is a clean space in which dust is extremely rare.

The storage disk 11 is mounted on the upper side of the motor 2 and is fixed thereto by means of a clamp 14. The access unit 12 includes a head portion 121 for accessing the storage disk 11 to read and write data magnetically; an arm 122 for supporting the head portion 121; and a head moving mechanism 123 for moving the arm 122 so that the head portion 121 is moved with respect to the storage disk 11 and the motor 2. With this construction, the head portion 121 gains access to a desired position on the storage disk 11 in a state that it comes close to the storage disk 11 under rotation, thereby performing the task of data reading/writing.

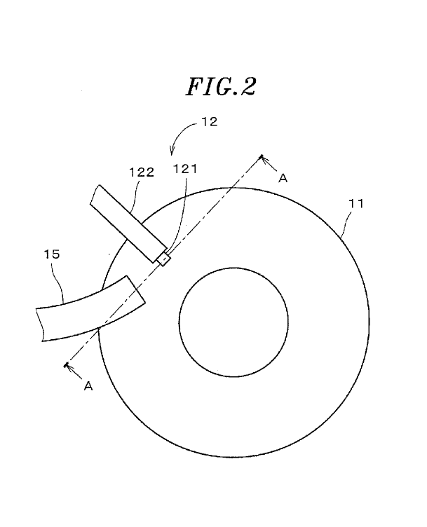

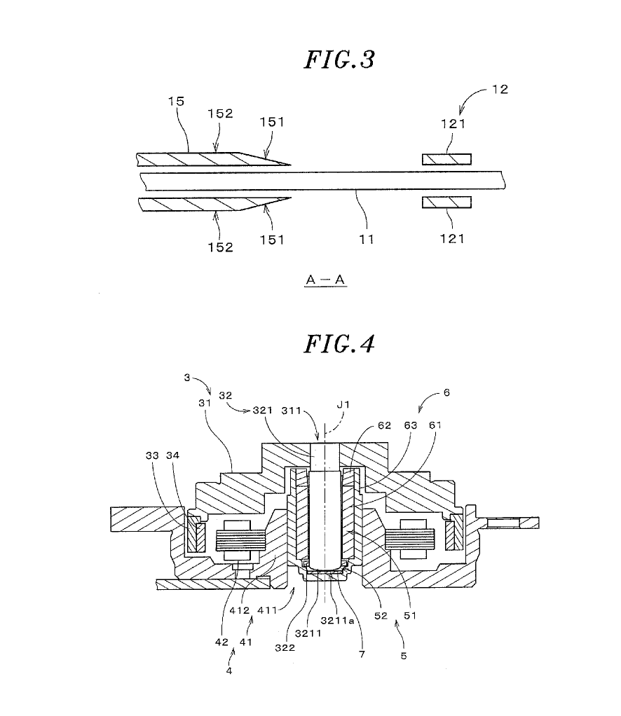

FIG. 2 is a plan view illustrating the placement of the access unit 12 and the ramp 15 relative to the storage disk 11. FIG. 3 is a sectional view of the access unit 12 and the ramp 15 taken along line A-A in FIG. 2. As shown in FIG. 3, the ramp 15 is arranged near both surfaces of the storage disk 11 so that the storage disk 11 is sandwiched by the ramp 15. When the arm 122 of the access unit 12 and the head portion 121 shown in FIG. 2 are retracted from the storage disk 11, the arm 122 is moved toward the ramp 15 by the head moving mechanism 123 (see FIG. 1). The head portion 121 enters the ramp 15 via a slanting surface 151 and an upper surface 152 formed at the tip end of the ramp 15. The head portion 121 is held immovable within a head receiving portion (not shown) of the ramp 15.

FIG. 4 is a sectional view of the motor 2 taken along a plane containing the central axis. The motor 2 is of an outer rotor type and includes a rotor unit 3 as a rotating assembly; a stator unit 4 as a fixed assembly; a substantially cylindrical bottom-closed sleeve unit 6 holding a lubricant therein; and a thrust plate 7 with elasticity disposed on the inner bottom surface of the sleeve unit 6. The thrust plate 7 is made of, e.g., a resin. The rotor unit 3 is rotatably supported by the stator unit 4 via a bearing mechanism 5 that includes the sleeve unit 6 and the thrust plate 7, so that the rotor unit 3 can rotate about the central axis J1 of the motor 2. In the following description, the direction toward the rotor unit 3 along the central axis J1 will be denoted by the term “upper”, and the direction toward the stator unit 4 along the central axis J1 will be signified by the term “lower”, for convenience. However, it is not necessary for the central axis J1 to coincide with the direction of gravity.

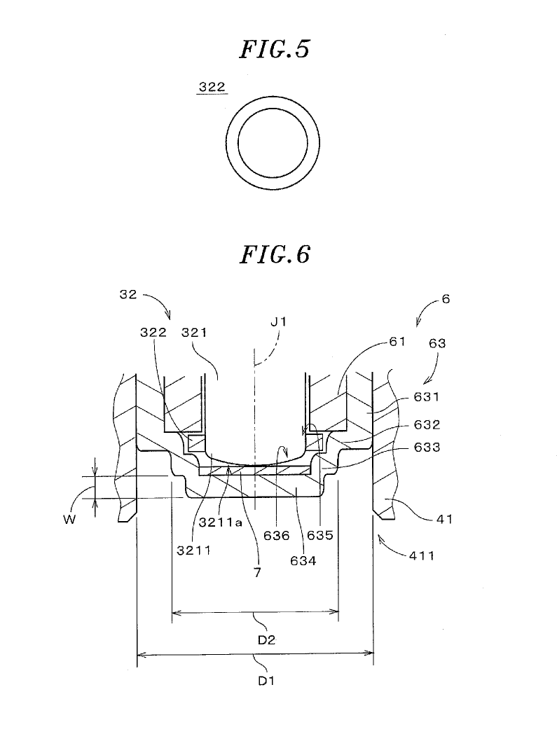

The rotor unit 3 includes a rotor hub 31 of substantially disk-like shape; a shaft unit 32 fixed to the central region of the rotor hub 31; a substantially cylindrical yoke 33 protruding downwardly from the outer circumference of the rotor hub 31; and an annular rotor magnet 34, magnetized with multiple poles, attached to the inner surface of the yoke 33. The rotor hub 31 is made of e.g., stainless steel. The storage disk 11 is mounted on an annular surface of the rotor hub 31 positioned above the rotor magnet 34 (see FIG. 1). The shaft unit 32 includes a shaft 321; and an annular removal-preventing member 322 (see the plan view shown in FIG. 5) fixed to the shaft 321 at a position slightly spaced apart from a lower end portion 3211 of the shaft 321. The shaft 321 is fixed at its upper end portion to a central opening 311 of the rotor hub 31. The lower end portion 3211 of the shaft 321 has an end surface 3211a of a substantially partial sphere shape. As will be set forth below, the shaft unit 32 may be regarded as a part of the bearing mechanism 5, in which case the shaft unit 32 functions as a component of the bearing mechanism 5 that is fixed to the rotor unit 3.

The stator unit 4 includes a base bracket 41 as a base portion having a bore 411 formed at its center; and a stator 42 attached to a holder 412 formed to surround the bore 411. The stator 42 includes a core formed of laminated silicon steel plates, and a coil wound around teeth of the core. The stator 42 generates rotational force (torque) acting about the central axis J1 between itself and the rotor magnet 34.

The sleeve unit 6 includes a substantially cylindrical sleeve 61 that is a lubricant-impregnated porous member; an annular seal cap 62 in contact with the upper surface of the sleeve 61; and a substantially cylindrical bottom-closed sleeve housing 63 into which the sleeve 61 and the seal cap 62 are inserted. The shaft 321 and the removal-preventing member 322 are held within the sleeve 61 and the sleeve housing 63.

FIG. 6 is a view enlargedly showing the bottom portion of the sleeve unit 6 and its neighborhood. The sleeve housing 63 includes a cylinder portion 631 making contact with the seal cap 62 (see FIG. 4) and the outer surface of the sleeve 61; a first step portion 632 of annular shape whose radial diameter is decreased from the lower end of the cylinder portion 631 toward the central axis J1; a second step portion 633 of annular shape formed below the first step portion 632 and having a diameter smaller than that of the first step portion 632; and a bottom portion 634 formed below the second step portion 633 for closing the lower end of the sleeve housing 63. The cylinder portion 631, the first step portion 632, the second step portion 633 and the bottom portion 634 are formed into a single member by being made of a press-formed metal plate. A cold-rolled steel plate, a galvanized steel plate or an austenitic stainless steel plate may be used as the metal plate.

In the sleeve unit 6, the region on the outer surface of the cylinder portion 631 of the sleeve housing 63 that is to be inserted into the bore 411 in the base bracket 41 is adhesively fixed to the inner surface of the bore 411, whereby the bearing mechanism 5 (see FIG. 4) as a whole is installed to the stator unit 4. The outer surface of the cylinder portion 631 has a diameter D1 of about 5 to 12 mm. The portion formed below the cylinder portion 631 has an outer diameter D2 of about 3 to 8 mm, and the bottom portion 634 has a thickness W of about 0.6 to 1.2 mm. In the following description, the upper surface (the upwardly facing surface) 6321 and the inner surface (the surface facing toward the central axis J1) of the first step portion 632, the upper surface 6331 and the inner surface 6332 of the second step portion 633, and the upper surface 6341 of the bottom portion 634 shown in FIG. 7 will be collectively referred to as an “inner bottom surface 635” of the sleeve housing 63.

As shown in FIG. 6, a recess portion 636 defined by the second step portion 633 and the bottom portion 634 is formed at the center of the inner bottom surface 635 of the sleeve 61. The thrust plate 7 is fitted into the recess portion 636, and the lower end portion 3211 of the shaft 321 is inserted into the recess portion 636. The inner diameter of the second step portion 633 is substantially the same as that of the sleeve 61. As can be seen in FIG. 7, the removal-preventing member 322 is received within an annular groove portion surrounded by the lower surface 611 of the sleeve 61, the inner surface 6322 of the first step portion 632 and the upper surface 6331 of the second step portion 633 with small gaps therebetween in the axial and radial directions. In other words, the removal-preventing member 322 is positioned between the upper surface 6331 of the second step portion 633 and the lower surface 611 (which is an end surface of the sleeve 61 that is closer to the inner bottom surface 635 than the other end surface of sleeve 61 is) of the sleeve 61, both of which are annular surfaces that face the recess portion 636. In this regard, the distance H1 between the lower surface of the removal-preventing member 322 and the upper surface 6331 of the second step portion 633 is about 0.03 to 0.1 mm. The distance H1 is set smaller than the distance between the ramp 15 and the storage disk 11 (see FIG. 3).

In the sleeve unit 6 as shown in FIG. 4, a lubricant is continuously filled in the gap around the removal-preventing member 322, and the gap between the outer surface of the shaft 321 and the inner surfaces of the sleeve 61 and the seal cap 62. The inner surface of the seal cap 62 includes a slanting surface whose diameter increases gradually with increasing height (see FIG. 4). Thus, a tapering gap whose width increases gradually with increasing height is formed between the inner surface of the seal cap 62 and the outer surface of the shaft 321. Consequently, leakage of the lubricant is prevented by a tapering seal having a boundary surface formed within the tapering gap.

Grooves (e.g., herringbone grooves) configured to generate a dynamic fluid pressure in the lubricant are formed on the inner surface of the sleeve 61, thereby forming a dynamic fluid pressure bearing 51 between the sleeve 61 and the shaft 321. During rotation of the motor 2, the sleeve 61 (especially the inner surface thereof) radially supports the shaft unit 32 via the lubricant. The grooves for generating the dynamic fluid pressure may be formed on the outer surface of the shaft 321 instead of the inner surface of the sleeve 61. As can be seen in FIG. 6, the thrust plate 7 and the end surface 3211a of the lower end portion 3211 of the shaft 321 make contact with each other somewhere along the central axis J1 with a small contacting force, thereby forming a pivot bearing 52 between the thrust plate 7 and the shaft 321. During rotation of the motor 2, the shaft unit 32 is rotatably supported by the pivot bearing in an axial direction (i.e., in a thrust direction). Diamond-like carbon (DLC) or other materials may be coated on the surface of the thrust plate 7 in an effort to increase the wear resistance thereof.

As shown in FIG. 4, the bearing mechanism 5 includes the dynamic fluid pressure bearing 51 and the pivot bearing 52. The shaft unit 32 may form a part of the bearing mechanism 5, and serves to implement the bearings 51 and 52 in cooperation with the sleeve unit 6, the thrust plate 7 and the lubricant. In the motor 2, the bearing mechanism 5 ensures that the rotor unit 3 (see FIG. 4) and the storage disk 11 (see FIG. 1) mounted to the rotor hub 31 are rotated with increased accuracy and with a reduced noise.

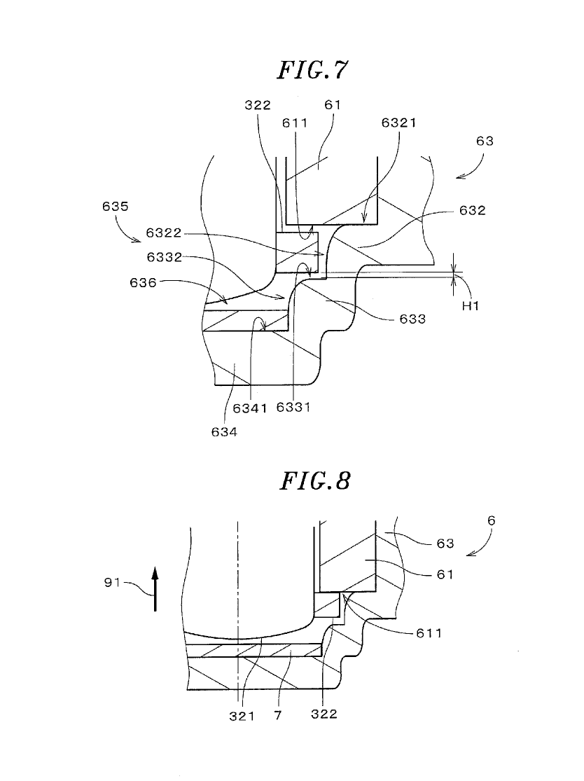

FIG. 8 illustrates a state in which a force is imparted to the shaft 321 in a direction of separating the shaft 321 from the sleeve 61. If the shaft 321 is moved away from the thrust plate 7 in the direction indicated by an arrow 91 (namely, in an upward direction), the upper surface of the removal-preventing member 322 comes into contact with the lower surface 611 of the sleeve 61, thereby preventing the shaft 321 from being pulled out of the sleeve unit 6. In this manner, the removal-preventing member 322, the sleeve 61 and the sleeve housing 63 constitute a removal-preventing mechanism in the motor 2.

FIG. 9 illustrates a state in which a force is imparted to the shaft 321 in a direction of inserting the shaft 321 into the sleeve 61 (i.e., in a direction in which the shaft 321 faces the inner bottom surface 635). As the shaft 321 is moved in the direction indicated by an arrow 92 (namely, in a downward direction), the lower surface of the removal-preventing member 322 comes into contact with the upper surface 6331 of the second step portion 633, thereby holding the shaft 321 against movement. At this time, the removal-preventing member 322 and the second step portion 633 (which form an annular portion that surrounds the recess portion 636) serve as a first contact portion of the shaft unit 32 and a second contact portion of the sleeve unit 6, respectively, thus preventing the thrust plate 7 from being excessively pressed by the lower end portion 3211 of the shaft 321. The removal-preventing member 322 makes contact with the second step portion 633 of the sleeve housing 63 when an overly great force acts against the shaft 321 in a downward direction (toward the stator unit 4), which occurs when, e.g., the storage disk 11 is fixed to the motor 2 with the clamp (see FIG. 1). During rotation of the motor 2, the removal-preventing member 322 does not make contact with the sleeve housing 63 in normal cases.

The description made above is directed to the structures of the storage disk drive apparatus 1 and the motor 2 in accordance with the first embodiment of the present invention. In the motor 2 described above, the removal-preventing member 322 restrains the shaft 321 from moving downwardly, even when an excessively great force acts against the shaft 321 in the downward direction. This protects the thrust plate 7 from being so pressed by the shaft 321 that the thrust plate 7 gets damaged (i.e., plastic deformation or rupture in the thrust plate 7 remains permanently). In view of this, the distance H1 between the lower surface of the removal-preventing member 322 and the upper surface 6331 of the second step portion 633 prior to a force being imparted to the shaft 321 in the direction of inserting the shaft 321 into the sleeve 61 (namely, the upper limit of the displacement of the shaft 321) is set smaller than the displacement of the shaft 321 that would cause damage to the thrust plate 7.

In the motor 2, the bottom portion 634 of the sleeve housing 63 has a thickness of about 0.6 to 1.2 mm, which makes it possible to secure rigidity without overly increasing the thickness of the bottom portion 634 (the details of which will be described later with reference to FIG. 14). This prevents the position of the shaft 321 from being displaced in the downward direction during rotation of the motor 2. Furthermore, since the upward movement of the shaft 321 is hindered by the removal-preventing member 322, the sleeve 61 and the sleeve housing 63, the vertical movement of the storage disk 11 is restrained (see FIG. 3). This prevents the ramp 15 and the storage disk 11 from making contact with each other. Moreover, the rigidity of the sleeve housing 63 is enhanced by forming the portion between the cylinder portion 631 and the bottom portion 634 of the sleeve housing 63 into a stepped shape. Thus, it is possible to reliably prevent the removal-preventing member 322 from making contact with the sleeve housing 63 during rotation of the motor 2.

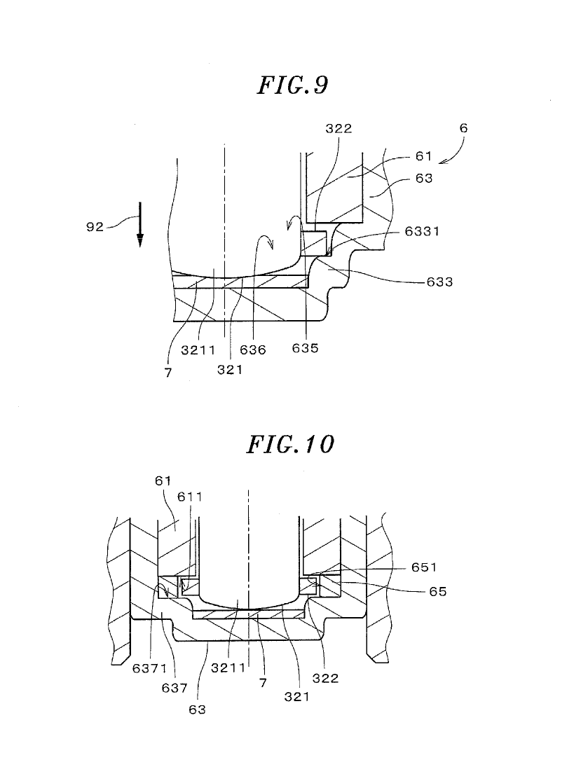

FIG. 10 is a view showing a modified example of the mechanism for preventing removal of the shaft 321 in the bearing mechanism 5 (see FIG. 4). In the sleeve housing 63 shown in FIG. 10, a single step portion 637 whose diameter decreases with decreasing height is provided instead of the first step portion 632 and the second step portion 633 shown in FIG. 6. An annular spacer 65 is fixed between the upper surface 6371 of the step portion 637 and the lower surface 611 of the sleeve 61. The removal-preventing member 322 is received within the annular groove portion surrounded by the upper surface 6371 of the step portion 637, the lower surface 611 of the sleeve 61 and the inner surface 651 of the spacer 65 with small gaps therebetween left in the vertical and radial directions.

Thus, the removal-preventing member 322, the sleeve 61 and the sleeve housing 63 constitutes a removal-preventing mechanism. When the shaft 321 is moved in the vertical direction, the removal-preventing member 322 makes contact with the lower surface 611 of the sleeve 61 and the upper surface 6371 of the step portion 637 of the sleeve housing 63, thereby holding the shaft 321 against movement. Particularly, even if an excessively great force acts on the rotor unit 3 (see FIG. 4) in the downward direction (i.e., toward the stator unit 4), the thrust plate 7 is not heavily pressed by the lower end portion 3211 of the shaft 321. This assists in preventing damage in the thrust plate 7.

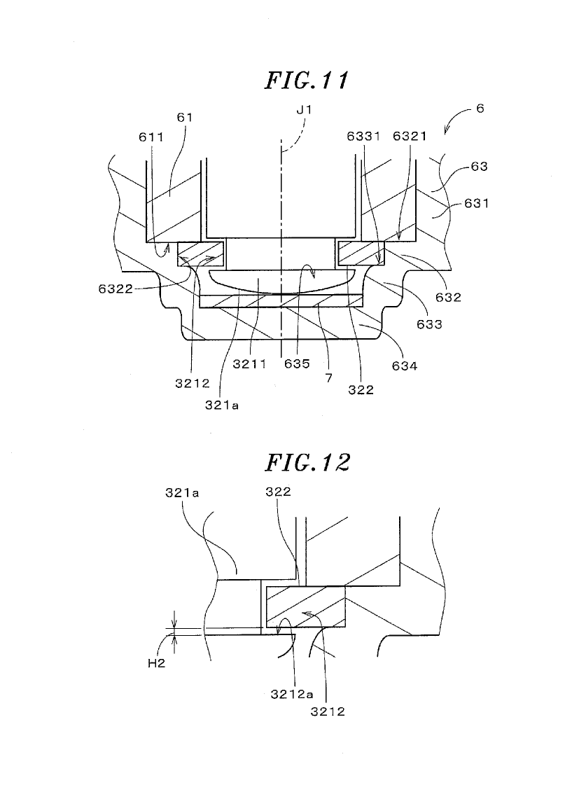

FIG. 11 is a view enlargedly showing the bottom portion of the sleeve unit 6 and its neighborhood in the motor according to a second embodiment of the present invention. Instead of the shaft 321 in the motor 2 of the first embodiment, the motor of the second embodiment includes a shaft 321a having an annular groove portion 3212 formed in a lower end portion 3211 to surround the central axis J1. The groove portion 3212 is radially recessed from the outer circumferential surface of the shaft 321a. The inner circumferential portion of the removal-preventing member 322 is arranged within the groove portion 3212 of the shaft 321a.

The removal-preventing member 322 has a thickness substantially equal to (or slightly greater than) the distance between the upper surface 6321 of the first step portion 632 and the upper surface 6331 of the second step portion 633 of the sleeve housing 63. Further, the removal-preventing member 322 has an outer diameter substantially equal to (or slightly greater than) the diameter of the inner surface 6322 of the first step portion 632. Thus, the outer circumferential portion of the removal-preventing member 322 is fixed between the lower surface 611 of the sleeve 61 and the upper surface 6331 of the second step portion 633 of the sleeve housing 63.

The axial width of the groove portion 3212 of the shaft 321a, which is measured in the direction of the central axis J1, is greater than the thickness of the removal-preventing member 322. Further, the diameter of the lateral boundary surface (the surface parallel to the central axis J1) of the groove portion 3212 is smaller than the inner diameter of the removal-preventing member 322. Thus, the inner circumferential portion of the removal-preventing member 322 is received within the groove portion 3212 with small gaps left between itself and the groove portion 3212 in the vertical and radial directions. As shown in FIG. 12, the distance H2 between the lower surface of the removal-preventing member 322 and the lower surface 3212a (the upwardly facing surface) on the groove portion 3212 of the shaft 321a is about 0.03 to 0.1 mm. The outer diameter of the sleeve housing 63 and other structures are same as those of the motor 2 in the first embodiment, and like components are designated by like reference numerals.

If the shaft 321a shown in FIG. 11 is moved upward, the lower surface of the removal-preventing member 322 makes contact with the groove portion 3212 of the shaft 321a, thereby holding the shaft 321a against movement. This prevents the shaft 321a from being pulled out of the sleeve unit 6 including the removal-preventing member 322. In this way, the removal-preventing member 322, the sleeve 61 and the sleeve housing 63 constitute a removal-preventing mechanism of the shaft 321a.

When a force acting from above the inner bottom surface 635 is applied to the shaft 321a, the upper surface of the removal-preventing member 322 makes contact with the groove portion 3212 of the shaft 321, thereby holding the shaft 321a against movement. That is to say, the groove portion 3212, which functions as a first contact portion of the shaft 321a, comes into contact with the removal-preventing member 322, which functions as a second contact portion of the sleeve unit 6, thereby restraining movement of the shaft 321a. The distance H2 (see FIG. 12) is set smaller than the displacement of the shaft 321a at which the thrust plate 7 would be pressed by the shaft 321a to be permanently deformed. This prevents damage (plastic deformation or rupture) in the thrust plate 7. Moreover, the rigidity of the sleeve housing 63 is enhanced by forming the portion between the cylinder portion 631 and the bottom portion 634 of the sleeve housing 63 into a stepped shape.

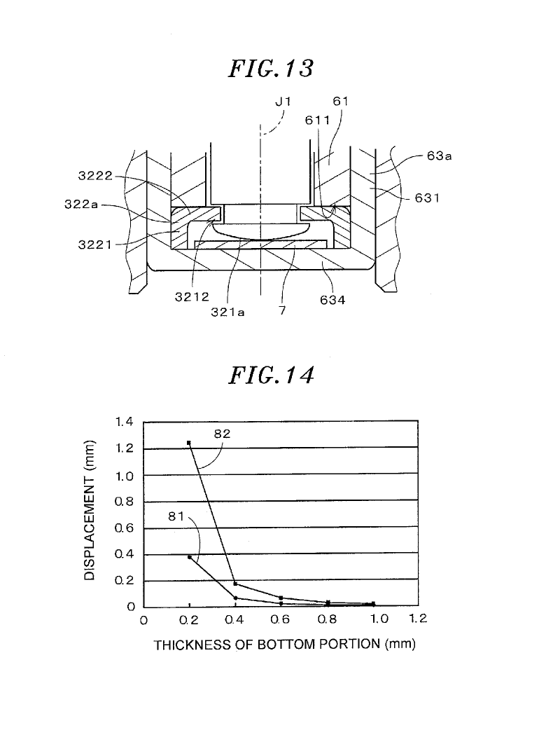

FIG. 13 is a view showing a modified example of the mechanism for preventing removal of the shaft 321a in the bearing mechanism. The sleeve housing 63a shown in FIG. 13 is not provided with the first and second step portions 632 and 633 of the sleeve housing 63 shown in FIG. 11, but is so structured that the lower end of the cylinder portion 631 is closed by the disk-like bottom portion 634. The cross-section of the removal-preventing member 322a taken along a plane containing the central axis J1 looks like two inverted L-shapes arranged opposite to each other. The removal-preventing member 322a includes a cylindrical portion 3221 making contact with the cylinder portion 631 and the bottom portion 634 of the sleeve housing 63a; and an annular plate portion 3222 protruding inwardly from the upper end of the cylindrical portion 3221. The lower surface 611 of the sleeve 61 makes contact with the upper surface of the annular plate portion 3222. The inner circumferential portion of the annular plate portion 3222 is received within the annular groove portion 3212 of the shaft 321a. Therefore, like the bearing mechanism shown in FIG. 11, the groove portion 3212 of the shaft 321a comes into contact with the inner circumferential portion of the annular plate portion 3222 of the removal-preventing member 322, thereby holding the shaft 321a against movement when a vertical force is applied to the shaft 321a. This makes it possible to prevent removal of the shaft 321a and damage in the thrust plate 7.

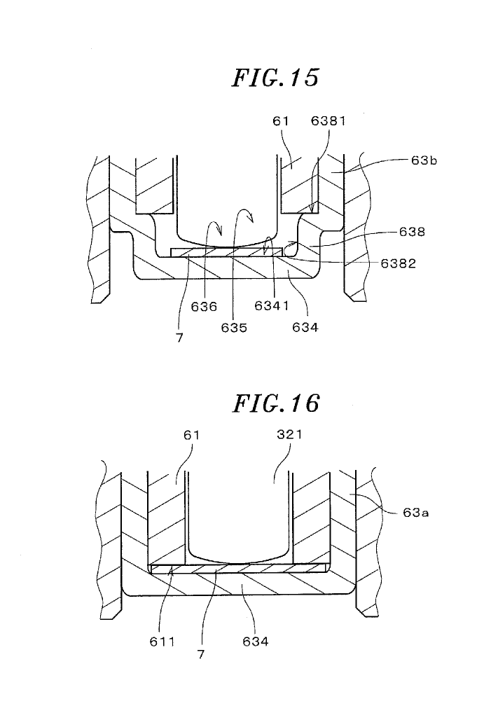

Next, description will be made on the strain acting on the sleeve housing when the sleeve housing and the thrust plate are pressed by the shaft. FIG. 14 is a view representing a computer simulation results for the relationship between the thickness of the bottom portion of the sleeve housing and the displacement of the center of the bottom portion when a force of 500 N is applied from the shaft to the sleeve housing. These results were obtained by using two kinds of the sleeve housings shown in FIGS. 15 and 16, both of which were 8 mm in the diameter of the outer surface of the cylinder portion. The curve 81 linking circular dots and the curve 82 linking square dots in FIG. 14 correspond to the sleeve housings shown in FIGS. 15 and 16, respectively. The force of 500 N applied to the bottom portion of the sleeve housing is equivalent to the pressing force acting on the rotor unit when a storage disk of 3.5 inch (about 8.9 cm) in diameter is mounted to the motor. This force is a criterion for determining the load resistance required in the sleeve housing.

Referring to FIG. 15, the bearing mechanism with a sleeve housing 63b has a simple structure in which the removal-preventing mechanism of the shaft 321 provided near the bottom portion 634 of the sleeve housing 63 shown in FIG. 6 is missing. Further, a single step portion 638 whose diameter becomes reduced with decreasing height is formed to surround the bottom portion 634 of the sleeve housing 63b.

The sleeve 61 makes contact with the upper surface 6381 of the step portion 638. The thrust plate 7 is fitted into the recess portion 636 formed at the center of the inner bottom surface 635 of the sleeve housing 63b, in which the inner bottom surface 635 consists of the upper surface 6381 and the inner surface 6382 of the step portion 638, and the upper surface 6341 of the bottom portion 634. Other structures are the same as those in the first embodiment, and like components are designated by like reference numerals. The sleeve housing 63b is made of press-formed steel plate such as a cold-rolled steel plate, a galvanized steel plate and/or an austenitic stainless steel plate that are formed by press working (this holds true in case of the sleeve housing shown in FIG. 16).

As indicated by the curve 81 in FIG. 14, the displacement becomes about 0.08 mm or less if the thickness of the bottom portion 634 of the sleeve housing 63b is 0.4 mm or more. This means that the bottom portion 634 is hardly deformed, and the rigidity of the bottom portion 634 is enhanced. In this case, the thrust plate 7 does not help to increase the rigidity of the sleeve housing 63b.

The bearing mechanism of the sleeve housing 63a shown in FIG. 16 has a common feature with that of the sleeve housing 63a shown in FIG. 13 in that the mechanism for preventing removal is missing from the shaft 321. The sleeve 61 is so arranged that the lower surface 611 thereof makes contact with the thrust plate 7. As indicated by the curve 82 in FIG. 14, the displacement becomes about 0.06 mm or less if the thickness of the bottom portion 634 in the sleeve housing 63a is 0.6 mm or more. This means that the bottom portion 634 is hardly deformed, and the rigidity of the bottom portion 634 is enhanced.

As described above, in a small-sized motor used for a storage disk drive apparatus, the rigidity of the sleeve housing is usually secured if the bottom portion 634 has a thickness of about 0.6 or more (about 1.2 mm or less for practical use) in case where the outer surface of the cylinder portion 631 of the sleeve housing has a diameter of about 8 mm. Thus, the storage disk 11 (see FIG. 1) mounted to the rotor unit 3 in the motor 2 is prevented from moving downwardly to an excessive extent when a force acting from above the inner bottom surface 635 of the sleeve housing is applied to the shaft 321. Further, plastic deformation in the sleeve housing is also avoided to prevent the storage disk 11 from being displaced downward from a normal position.

According to the measurement results mentioned above, it is presumed that the rigidity of the bottom portion 634 of the sleeve housing is secured although the outer surface of the cylinder portion 631 has different diameters within a range of about 5 to 12 mm. This is particularly suitable for the motor used for the storage disk drive apparatus having the above-mentioned ramp. Comparing the curves 81 and 82 shown in FIG. 14, it can be seen that the sleeve housing 63b is more rigid than the sleeve housing 63. Therefore, a structure having a step portion is preferred.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

In the first and second embodiments described above, a C-shaped or an internal gear type retainer ring may be used as the removal-preventing member 322 instead of the one shown in FIG. 5. In the first embodiment, the shaft 321 and the removal-preventing member 322 may be formed into a single member. Likewise, the sleeve 61 and the spacer 65 shown in FIG. 10 may be formed into a single member.

In the foregoing embodiments, a small depression may be formed at the center of the thrust plate 7 opposite to the end surface 3211a of the shaft 321. Moreover, the lower end portion 3211 of the shaft 321 may be formed into a planar shape, and may make pointwise contact with a thrust plate having a depression of a partial spherical shape formed at the center thereof, thereby axially supporting the shaft 321.

The structure that allows the shaft unit including the shaft and the sleeve unit radially supporting the shaft to make contact with each other when a force acting from above the inner bottom surface of the sleeve housing is applied to the shaft is not limited to the ones illustrated in the foregoing embodiments, but may be many other structures. For example, a guard portion may be provided in the upper portion of the shaft so that the guard portion of the shaft and the upper end surface of the sleeve can make contact with each other to prevent damage of the thrust plate 7.

Further, the structure of the ramp of the storage disk drive apparatus 1 is not limited to the one holding the storage disk 11 in a sandwiching manner, but may be other structures. In any case, the contact between the ramp arranged near at least the surface of the storage disk 11 facing toward the motor 2 and the storage disk 11 is prevented by the bearing mechanism described above. The storage disk drive apparatus 1 is not limited to the ones illustrated in the foregoing embodiments, insofar as it is capable of performing one or both of the tasks of reading and writing data from and to the storage disk 11. Furthermore, the motor 2 may be used in a removable disk drive apparatus for driving an optical disk or a magnetic disk, and other disk drive apparatuses.

What is claimed is:

1. A bearing mechanism for use in a motor in a storage disk drive apparatus, comprising:
a substantially cylindrical bottom-closed sleeve unit;
a shaft unit supported by the sleeve unit via a lubricant in a radial direction; and
an elastic thrust plate arranged on an inner bottom surface of the sleeve unit to be in contact with an end portion of the shaft unit at a position on a central axis to rotatably support the shaft unit in an axial direction,
wherein the shaft unit has a first contact portion, the sleeve unit has a second contact portion, and the first and the second contact portion are so arranged that, when a force acting from above the inner bottom surface of the sleeve unit is applied to the shaft unit, movement of the shaft unit is restrained by the first and the second contact portion making contact with each other, and
wherein a distance between the first and the second contact portion prior to the force being applied to the shaft unit is smaller than the displacement of the shaft unit at which the thrust plate gets so pressed by the shaft unit to be permanently deformed.

2. The bearing mechanism of claim 1, wherein the sleeve unit includes a sleeve, and a substantially cylindrical bottom-closed sleeve housing into which the sleeve is inserted, and
wherein the shaft unit includes a shaft, and an annular removal-preventing member fixed to the shaft at a position spaced apart from the end portion of the shaft unit.

3. The bearing mechanism of claim 2, wherein the sleeve housing has a recess portion formed substantially at a center of the inner bottom surface of the sleeve unit to receive the end portion of the shaft unit, the thrust plate being disposed within the recess portion,
wherein the removal-preventing member is arranged between an annular portion surrounding the recess portion and an end surface of the sleeve facing toward the inner bottom surface, and
wherein the first contact portion of the shaft unit is the removal-preventing member, and the second contact portion of the sleeve unit is the annular portion surrounding the recess portion.

4. The bearing mechanism of claim 2, wherein the sleeve housing includes a cylinder portion, and a step portion whose diameter is decreased in a radially inward direction from a lower end portion of the cylinder portion, and
wherein the first contact portion includes a lower surface of the removal-preventing member, and the second contact portion includes an upper surface of the step portion.

5. The bearing mechanism of claim 4, wherein the sleeve housing includes a bottom portion extending from the step portion to close a lower portion of the sleeve housing, and the inner bottom surface is an upper surface of the bottom portion.

6. The bearing mechanism of claim 4, wherein the step portion includes a first step portion whose diameter is decreased in the radially inward direction below the cylinder portion, and a second step portion whose diameter is further decreased from a lower end of the first step portion.

7. The bearing mechanism of claim 4, wherein the sleeve housing includes a spacer interposed axially between the sleeve and the step portion, and being radially opposite to the removal-preventing member via a gap therebetween.

8. The bearing mechanism of claim 1, wherein the sleeve unit includes a sleeve, a substantially cylindrical bottom-closed sleeve housing into which the sleeve is inserted, and an annular removal-preventing member, and
wherein the shaft unit includes a shaft.

9. The bearing mechanism of claim 8, wherein the shaft has a groove portion recessed in a radially inward direction from an outer circumferential surface of the shaft, and the removal-preventing member has an inner circumferential portion arranged within the groove portion, and
wherein the first contact portion includes a surrounding surface of the groove portion, and the second contact portion includes an upper surface of the removal-preventing member.

10. The bearing mechanism of claim 9, wherein the sleeve housing includes a cylinder portion, and a step portion whose diameter is decreased in a radially inward direction from a lower end portion of the cylinder portion, and
wherein the removal-preventing member is disposed between and brought into contact with the step portion and the sleeve.

11. The bearing mechanism of claim 10, wherein the sleeve housing includes a bottom portion extending from the step portion to close a lower portion of the sleeve housing, and the inner bottom surface is an upper surface of the bottom portion.

12. The bearing mechanism of claim 10, wherein the step portion includes a first step portion whose diameter is decreased in a radially inward direction from the lower end portion of the cylinder portion, and a second step portion whose diameter is further decreased below the first step portion, and
wherein the removal-preventing member is disposed between and brought into contact with an upper surface of the second step portion and the sleeve.

13. The bearing mechanism of claim 8, wherein the removal-preventing member includes a cylindrical portion being in contact with the inner bottom surface of the sleeve unit, and an annular plate portion protruding inwardly from an upper end of the cylindrical portion,
wherein the shaft has a groove portion recessed in a radially inward direction from an outer circumferential surface of the shaft, and the annular plate portion is arranged within the groove portion, and
wherein the first contact portion includes a surrounding surface of the groove portion, and the second contact portion includes an upper surface of the annular plate portion.

14. The bearing mechanism of claim 1, further comprising:
a sleeve housing made of a press-formed plate member.

15. The bearing mechanism of claim 14, wherein the plate member is a cold-rolled steel plate, a galvanized steel plate or an austenitic stainless steel plate.

16. The bearing mechanism of claim 2, wherein the sleeve housing has an outer surface portion inserted into and fixed to a specified aperture, a diameter of the outer surface portion being about 5 to 12 mm, and
wherein the sleeve housing has a bottom portion whose thickness is about 0.6 to 1.2 mm.

17. The bearing mechanism of claim 1, wherein a dynamic fluid pressure bearing with a groove configured to generate a dynamic fluid pressure in the lubricant is formed between the shaft unit and the sleeve unit.

18. An electric motor comprising:
the bearing mechanism of claim 1;
a rotor unit fixed to the shaft unit in the bearing mechanism; and
a stator unit to which the bearing mechanism is installed.

19. A storage disk drive apparatus comprising:
the motor of claim 18 for rotating a storage disk;
an access unit for reading and writing data from and to the storage disk; and
a housing that receives the motor and the access unit.

20. The storage disk drive apparatus of claim 19, further comprising:
a ramp, arranged at least near a surface of the storage disk facing toward the motor,
wherein, when a head portion of the access unit is retracted from the storage disk, the ramp holds the head portion in position.
